(19) United States
(12) Patent Application Publication
(10) Pub. No.: US 2016/0040715 A1
(43) Pub. Date: Feb. 11, 2016

(54) ROLLER THRUST BEARING WITH RADIAL CAGE CLEARANCE

(71) Applicant: Schaeffler Technologies AG & Co. KG, Herzogenaurach (DE)

(72) Inventors: James Kevin BROWN, Rock Hill, SC (US); Charles SCHWAB, Fort Mill, SC (US); Andreas ZIEGLER, Charlotte, NC (US); Eric S. NELSON, Charlotte, NC (US); Michael TURNER, Fort Mill, SC (US)

(73) Assignee: Schaeffler Technologies AG & Co. KG, Herzogenaurach (DE)

(21) Appl. No.: 14/805,908

(22) Filed: Jul. 22, 2015

Related U.S. Application Data
(60) Provisional application No. 62/033,837, filed on Aug. 6, 2014.

(51) Int. Cl. F16C 33/46; F16C 33/54; F16C 19/30

(52) U.S. Cl. CPC F16C 33/467; F16C 19/305; F16C 33/4635; F16C 33/4629; F16C 33/543

(57) ABSTRACT

A roller thrust bearing including a first ring including a first radial portion, and a second ring including a radially inner flange and a second radial portion is provided. Rolling elements each having a length are supported between the first ring and the second ring. A cage including an annular body defines a plurality of pockets, and the rolling elements are located in at least some of the pockets. The pockets each have a radial opening, and the length of the rolling elements is less than a length of the radial opening of the pockets, defining a clearance between at least one end side of each of the rolling elements and at least one radial end face of respective ones of the pockets that contain the rolling elements. The clearance provides radial play between each of the rolling elements and the respective ones of the pockets.

### INCORPORATION BY REFERENCE

The following documents are incorporated herein by reference as if fully set forth: U.S. Provisional Patent Application No. 62/033,837, filed Aug. 6, 2014.

### FIELD OF INVENTION

The present invention relates to a bearing arrangement, and more particularly to a roller thrust bearing for accommodating an eccentric running condition.

### BACKGROUND

Roller thrust bearings are known and used in a variety of applications for supporting axial loads. Roller thrust bearings typically include rolling elements, two rings that define raceways for the rolling elements, and a cage including pockets for carrying the rolling elements. Known roller thrust bearings are used in applications that occasionally experience eccentric running conditions. These eccentric running conditions cause the rolling elements to be forced against and/or dig into the ends of pockets formed in the cage. One type of known axial thrust bearings includes two rings, a first ring including a radial portion defining a raceway and a radially inner flange, and a second ring including a radial portion defining a raceway and a radially outer flange. This type of “encapsulated” bearing arrangement can fail during eccentric running conditions due to the cage being pressed or pinched between the radially inner flange and outer flange, causing the cage to fracture. Other known axial thrust bearings include two rings, a first ring including a radial portion defining a raceway and a radially inner flange, and a second ring including a radial portion defining a raceway and lacking any radial flange. The cages of these known axial thrust bearings also experience failure during eccentric running conditions due to the rolling elements digging into the ends of the cage pockets. It would be desirable to provide a durable roller thrust bearing arrangement that is capable of accommodating a range of radial movement of the rolling elements caused by eccentric running conditions without causing the cage to fracture.

### SUMMARY

Briefly stated, a roller thrust bearing including a clearance between end sides of rolling elements and radial end faces of pockets formed in a cage is provided. The roller thrust bearing includes a first ring including a first radial portion defining a first raceway. A second ring includes a radially inner flange and a second radial portion defining a second raceway. Rolling elements each having a length are supported between the first ring and the second ring, and the rolling elements run on the first raceway and the second raceway. A cage including an annular body defines a plurality of pockets, and the rolling elements are located in at least some of the pockets. The pockets each have a radial opening, and a length of the rolling elements is less than a length of the radial opening of the pockets to provide a clearance between at least one end side of each of the rolling elements and at least one radial end face of respective ones of the pockets that contain the rolling elements. The clearance provides radial play between each of the rolling elements and the respective ones of the pockets.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view through a roller thrust bearing according to the present invention.

FIG. 2 is a top view of a cage of the roller thrust bearing of FIG. 1.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “radially inwardly” and “radially outwardly” refer to directions radially toward and away from an axis of the part being referenced. “Axially” refers to a direction along the axis of a shaft or other part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

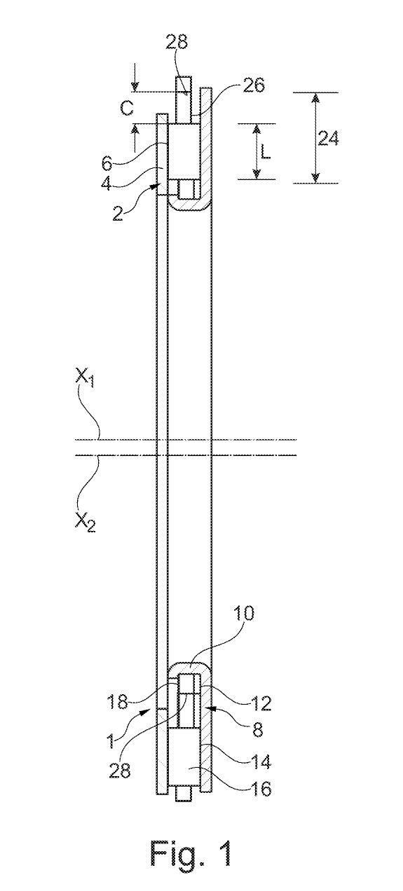

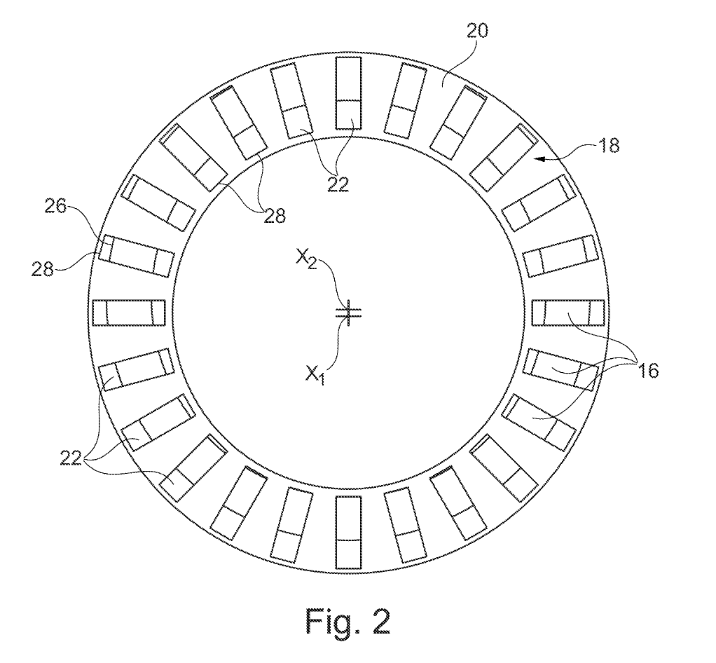

Referring to FIG. 1, a roller thrust bearing 1 is shown. The roller thrust bearing includes a first ring 2 having a first radial portion 4 defining a first raceway 6. A second ring 8 includes a radially inner flange 10 and a second radial portion 12 defining a second raceway 14. A plurality of rolling elements 16 each having a length L are arranged between the first ring 2 and the second ring 8. In one preferred embodiment, the rolling elements 16 are cylindrical rollers. The rolling elements 16 run on the first raceway 6 and the second raceway 14. As shown in FIGS. 1 and 2, a cage 18 is provided that includes an annular body 20 defining a plurality of pockets 22. In one preferred embodiment the cage 18 is formed from stamped sheet metal. In another preferred embodiment, the cage 18 is formed from molded polymeric material. In another preferred embodiment, the cage 18 is formed from sintered metal. The pockets 22 of the cage 18 each have a defined radially extending opening 24. The rolling elements 16 are located in at least some of the pockets 22.

The length L of the rolling elements 16 is less than a length of the radial opening 24 of the pockets 22. Due to the difference between the length L of the rolling elements 16 and the length of the radial opening 24 of the pockets 22, a clearance C is provided between end sides 26 of each of the rolling elements 16 and radial end faces 28 of respective ones of the pockets 22 that contain the rolling elements 16. This clearance C provides radial play between each of the rolling elements 16 and the respective ones of the pockets 22. The radial play allows the roller thrust bearing 1 to accommodate eccentric running conditions without causing the rolling elements 16 to dig or drill into the radial end faces of the pockets 22. As shown in FIGS. 1 and 2, the cage 18 is rotatable about a first axis (X₁), and at least one ring and the rolling elements 16 are rotatable about a second axis (X₂) that is offset from the first axis (X₁). In a preferred embodiment, the first ring 2 and the rolling elements 16 are rotatable about the second axis (X₂) that is offset from the first axis (X₁). In one preferred embodiment, the length L of the rolling elements 16 extends between 50-80% of the length of the radial opening 24 of the pockets 22. In another more preferred embodiment, the length L of the rolling elements 16 extends between 60-70% of the length of the radial opening 24 of the pockets 22.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A roller thrust bearing comprising:
a first ring including a first radial portion defining a first raceway;
a second ring including a radially inner flange and a second radial portion defining a second raceway;
rolling elements each having a length, the rolling elements are supported between the first ring and the second ring, and the rolling elements run on the first raceway and the second raceway; and
a cage including an annular body defining a plurality of pockets, the rolling elements being located in at least some of the pockets, the pockets each having a radial opening, the length of the rolling elements is less than a length of the radial opening of the pockets to provide a clearance between at least one end side of each of the rolling elements and at least one radial end face of respective ones of the pockets that contain the rolling elements.

2. The roller thrust bearing of claim 1, wherein the length of the rolling elements extends between 50-80% of the length of the radial opening of the pockets.

3. The roller thrust bearing of claim 1, wherein the length of the rolling elements extends between 60-70% of the length of the radial opening of the pockets.

4. The roller thrust bearing of claim 1, wherein the rolling elements are cylindrical rollers.

5. The roller thrust bearing of claim 1, wherein the cage is formed from stamped sheet metal.

6. The roller thrust bearing of claim 1, wherein the cage is formed from molded polymeric material.

7. The roller thrust bearing of claim 1, wherein the cage is formed from sintered metal.

8. The roller thrust bearing of claim 1, wherein the cage is rotatable about a first axis, and at least one ring and the rolling elements are rotatable about a second axis that is offset from the first axis.
